(19) United States
(12) Patent Application Publication
(10) Pub. No.: US 2001/0006426 A1
(43) Pub. Date: Jul. 5, 2001

(54) Holographic projection screen for displaying a three-dimensional color images and optical display system using the holographic screen

(75) Inventors: Jung Young Son, Kyung-Ki do (KR); Vladimir Ivanovich Bobrinev, Moscow (RU)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Korea Institute of Science and Technology, Seoul (KR)

(21) Appl. No.: 09/768,624

(22) Filed: Jan. 25, 2001

Related U.S. Application Data
(63) Continuation-in-part of application No. 09/432,410, filed on Nov. 2, 1999, now Pat. No. 6,211,977.
Application No. 09/432,410 is a continuation-in-part of application No. 08/897,052, filed on Jul. 18, 1997, now abandoned.

(30) Foreign Application Priority Data
Jul. 18, 1996 (KR) 1996-28966

(51) Int. Cl. G03H 1/00; G02B 5/32; G03H 1/26; G03H 1/02; G02B 27/22

(52) U.S. Cl. 359/15; 359/1; 359/23; 359/28; 359/462

(57) ABSTRACT

A method is proposed, how to produce a holographic screen for projection of the three-dimensional color images, where a narrow and elongate slit-shaped diffuser is recorded on a hologram as an object to ensure the well defined viewing zone forming in the course of the image projection. Further to the back side of the holographic screen a mirror is attached to transform it into reflection mode of operation. Further, the holographic screen is rotated under a control of an eye-tracking system to provide viewing zone movement together with a viewer's eye. Also, a diffuser with vertical light scattering is attached to a surface of the holographic screen to increase a vertical size of a viewing zone of the holographic screen. In addition, two or more holographic screens manufactured by this method are combined in a mosaic manner to form a big size holographic screen.

This application is a continuation-in-part of U.S. Ser. No. 09/432,410, filed on Nov. 2, 1999, which is a continuation-in-part of U.S. Ser. No. 08/897,052, filed on Jul. 18, 1997 and now abandoned.

### BACKGROUND OF THE INVENTION

1. Field of the Invention

The invention relates generally to an application technique using holography, and more particularly, to a projection holographic screen for displaying a three-dimensional color images and an optical display system using the holographic screen.

2. Description of the Related Art

A projection holographic screen is a kind of holographic optical element that serves as a general image display screen where an image, being projected on the screen, can be observed if an eye is disposed within a limited viewing zone. In order to observe a stereoscopic or multiview image, the viewing zones should be narrow enough to deliver to the left and right eyes of the viewer the left and right images correspondingly. For projection of the stereoscopic image the viewing zone centers should be spaced apart from each other by an eye-to-eye distance (about 6.5 cm).

There are two types of the projection holographic screens known in the art, i.e., a reflection type and a transmission type. The holographic screen of the reflection type selectively displays only an image projected through a projector on the screen and serves as a reflection mirror having a focusing capacity which allows an image of the exit pupil of a projection lens to be focused to form the viewing zone. However, as this type of holographic screen has a high angular and spectral selectivity, only a monochromatic image with a limited viewing zone can be displayed on the screen. Further, three holographic screens of the reflection type formed by red, blue and green lasers should be stacked to display a color image.

The transmission type holographic screen is formed as hologram of the diffusive light scatterer. When the screen is illuminated by the projected image the light scattered by the screen surface is directed to the predefined domain or viewing zone. The properly produced holographic screen as seen from the viewing zone should have the uniform illumination of all its surface and true color reproduction. These peculiarities depend of the screen recording method.

In the conventional setup for the holographic screen recording as disclosed, for example, in U.S. Pat. No. 4,799,739 and PCT International Publication WO 93/02372, a converging reference wave is made to interfere on a holographic photoplate with an object wave incident upon the photoplate via a diffuser. Being illuminated by the projector, the holographic screen is forming the real image of the diffuser in front of the screen, the viewing zone coincides with this image. The most serious drawback of the described setup is necessity to use big size optics for the screen recording: at least one lens should be bigger than screen itself.

Therefore, the holographic screen manufactured by the conventional setup has the limited size, and producing big size screens is very cumbersome problem.

Also, in the conventional setup, when the viewer moves his (her) eyes from the viewing zone, the viewer can not watch 3D images.

Furthermore, in general, the viewing zone of the holographic screen has a relatively small extension in the vertical direction. Thus, it is necessary to adjust optical arrangement in the optical display system to correspond to the viewer's height.

### SUMMARY OF THE INVENTION

An object of the present invention is to provide a holographic screen for displaying a stereoscopic or multiview color image without big size optical elements in the screen recording setup, which is optimized by mathematically analyzing the image reproduction process via the produced holographic screen.

Another object of the present invention is to provide a large holographic screen required by an user.

Yet another object of the present invention is to provide an optical display system which is capable of providing stereoscopic or multi-view images to a viewer even when his (her) eyes move from specified position of a viewing zone.

Yet another object of the present invention is to provide an optical display system allowing the viewing zone of the holographic screen to extend in the vertical direction.

According to one aspect of the present invention, there is provided an optical display system for displaying stereoscopic or multi-view color images comprising: a holographic screen; and two or more image projectors which project the stereoscopic or multi-view color images on said holographic screen, a distance between exit pupils of the two or more image projectors being decided depending on a viewer's inter-eye distance, wherein said holographic screen is formed by a method including the steps of: (a) placing a photoplate on an x-y plane of a three dimensional space, wherein the center of the photoplate is disposed in the origin of the three dimensional space; (b) splitting the laser beam into two beams: reference beam and object beam, both beams being used to illuminate the photoplate surface; (c) shaping the reference beam as a sperical wave diverging from a point on a z-axis which is located a distance R₁ from the photoplate center; (d) shaping the object beam so as to illuminate the photoplate through an elongated narrow slit-shaped diffuser inclined to the photoplate surface; and (e) recording an interference pattern, which is arising as a result of the superposition of the reference wave with an object wave from the diffuser on the photoplate, whereby the stereoscopic or multiview three dimensional color images is displayed on a recorded screen by the projectors disposed at a distance R₃ from the screen, if a viewer's eyes are placed at viewing zones which are located behind the screen at a distance R₄ the viewing zones being composed of superposed diffuser's real images of the different colors, wherein the coordinates of the diffuser point, which is responsible for the contribution of a light with a wavelength λ₂ in the viewing zone, are calculated from the following equations:

k₂r₃+k₁(r₁-r₂)=−k₂r₄+const (1)

$$\begin{matrix}α = {sin}^{- 1} [ \frac{{k}_{2}}{{k}_{1}} sin β ] = {sin}^{- 1} [ \frac{{λ}_{1}}{{λ}_{2}} sin β ] & ( 2 ) \\ {R}_{2} = \frac{{R}_{1}}{1 + \frac{2 {λ}_{1} {R}_{1}}{{λ}_{2} {R}_{4}}} & ( 3 )\end{matrix}$$

where r₁ is the distance between an arbitrary point (x,y) on the photoplate and a position of the source of the reference beam; r₂ and R₂ are the distances between a point (x,y) on the photoplate and a point on the diffuser and between the coordinate origin and the same diffuser point; a is the angle between R₂ straight line and the z-axis; r₃ is the distance between a point (x,y) on the photoplate and a point source of the projection beam; r₄ is the distance between a point (x,y) on the photoplate and a viewing zone; R₄ is the distance between an origin and a viewing zone; β is the angle between R₄ straight line and the z-axis; λ₁ and λ₂ represent wavelengths of the recording and projecting waves, respectively; k₁ and k₂ are wave numbers of the recording and projecting waves, respectively, wherein the diffuser's length and position are calculated using equations (2) and (3) for covering an entire spectral range of a projected image.

Preferably, the optical display system according to present invention further comprises a reflecting means attached to the back side of said holographic screen for allowing said holographic screen to operate in a reflection mode. Also, the optical display system can comprise a means for rotating said holographic screen; and an eye-tracking system for tracking a viewer's eye movement to control an operation of said rotating means, whereby said holographic screen is rotated in accordance with the viewer's eye movement.

Further, it is desirable that said holographic screen are combined in such a manner that their viewing zones coincide in a viewer's position, to thereby provide a large stereoscopic or multi-view image.

Furthermore, the optical display system according to the present invention may further comprise a vertical diffusing means attached to a surface of said holographic screen, wherein said vertical diffusing means generates vertical light scattering on the surface of said holographic screen to increase a vertical size of the viewing zone to be formed by said holographic screen. The diffusing means may be formed as a bleached photograph of a speckle pattern, said speckle pattern being obtained by scattering a thin line of laser light to a ground glass. Alternatively, the diffusing means may be formed as a diffraction grating with vertical direction of dispersion, said diffraction grating having such a grating period that neighboring diffraction orders are separated at the viewer position by a distance equal to an diameter of the viewing zone.

### BRIEF DESCRIPTIONS OF THE DRAWINGS

The aforementioned aspects and other features of the present invention will be explained in the following description, taken in conjunction with the accompanying drawings, wherein:

FIG. 1 is a schematic view showing an optical arrangement for producing a holographic screen according to the present invention;

FIG. 2 is a schematic view illustrating the viewing zone forming, when a holographic screen, as produced according to the present invention is illuminated by the image projector;

FIG. 3a and 3b are a side view and a top view showing an optical arrangement for displaying stereoscopic image using a holographic screen produced according to the present invention;

FIG. 4 is a schematic view showing an optical arrangement for displaying stereoscopic image using a holographic screen produced according to the present invention as a reflection type holographic screen;

FIG. 5 is a schematic view of an optical arrangement for producing a big size screen by mosaicking several holographic screens produced according to the present invention;

FIG. 6 is a schematic view of the optical display system with eye-tracking capability, wherein the holographic screen produced according to the present invention is rotated under a control of the eye-tracking system; and

FIG. 7 is a schematic view of the optical display system which is provided with a holographic screen produced according to the present invention, which has an extended vertical size of viewing zone.

### DETAILED DESCRIPTION OF THE PRESENT INVENTION

The present invention will be described in detail by way of a preferred embodiment with reference to accompanying drawings, in which like reference numerals are used to identify the same or similar parts.

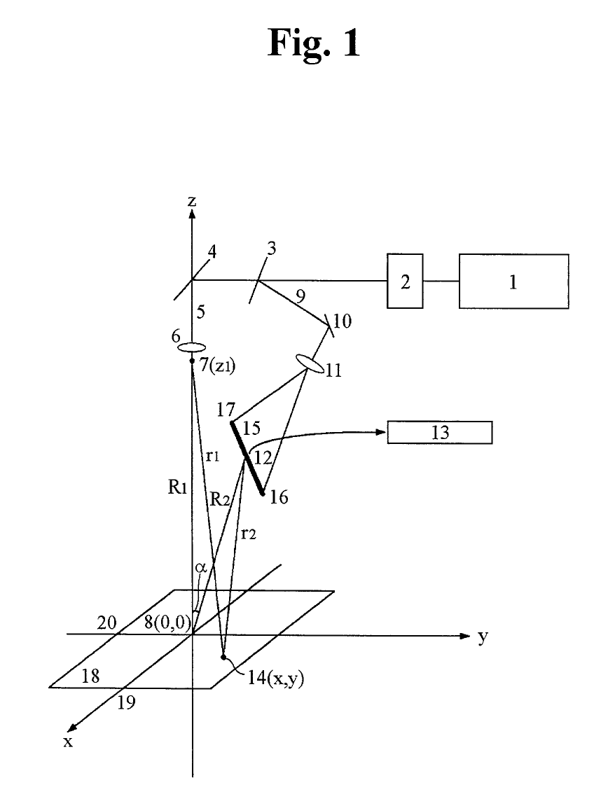

As shown on FIG. 1, a light beam from laser 1 after shutter 2 is divided into two beams by the beam-splitter 3. One of the obtained beams, namely reference beam 5 is reflected from the mirror 4 and focused by the lens 6 to the point 7 on the z-axis with coordinate z₁ to form a diverging reference beam for the holographic screen recording on the photoplate 18. Usage of the diverging reference beam, unlike the previous art, makes it possible to use small size optics for the screen recording. The photoplate is disposed in the xy-plane and centered to the coordinate system origin 8. Second beam after beamsplitter 3, namely object beam 9, after reflection from mirror 10 is formed by the lens 11 so as to illuminate the diffuser 12 (the slit-shaped diffuser made of ground glass is shown as 13). Slit-shaped diffuser, stretched in the plane y-z, is used to provide later on forming the well defined viewing zone, which is necessary for the stereoscopic imaging. 14 is an arbitrary point on the photoplate surface with coordinates x, y; 15—a point on the diffuser, 16 and 17 are correspondingly the nearest to the photoplate and the most distant from it points of the diffuser; 19 and 20 are correspondingly short side and long side of the photoplate; r₁ is the distance between a point 14 on the photoplate and a point 7—source of the diverging reference beam; r₂ is the distance between a point 14 on the photoplate and a point 15 on the diffuser; R₂ is the distance between the origin 8 and a point 15; α is the angle between the positive z-axis and a straight line connecting the origin 8 to the point 15.

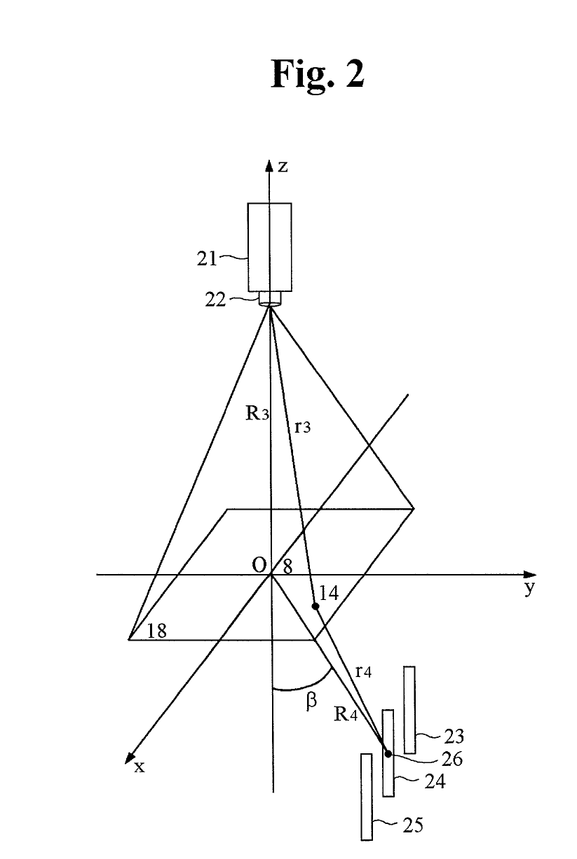

On the FIG. 2 the principle of the viewing zone forming is illustrated when the holographic screen as produced in the setup of FIG. 1 is illuminated by the projector light. The projector 21 with the exit pupil 22 is used for projection on the screen 18 of the image to be viewed. Because of the holographic screen properties, the light diffracted on it is not scattered randomly, but is collected to produce in the space image of diffuser. As a result the bright image, projected on the screen, can be seen only if the viewer's eye is disposed in the diffuser image. As compared with the previously known art we are using the conjugate real image of the diffuser for forming the viewing zone. Reference numerals 23, 24 and 25 are conjugate images of the diffuser, as restored by different spectral components of the projector light. Because of the screen dispersion, the red image of the diffuser 23 will be diffracted on the bigger angle and will be disposed more close to the screen, than green image 24 or blue one 25. If the screen recording scheme is optimal, the diffuser images of all of the colors are overlapped in the vicinity of the point 26 and the full color image on the screen can be seen by the eye disposed in the point 26. There are shown also in the FIG. 2: r₃—the distance between a point 14 on the photoplate (the same on the FIG. 1 and FIG. 2) and a point 22—source of the projection beam on the FIG. 2; r₄—the distance between a point 14 on the photoplate and a point 26—the point of the restored diffuser image on the FIG. 2; R₄—the distance between origin 8 (the same on the FIG. 1 and FIG. 2) and a point 26—the point of the restored diffuser image on the FIG. 2; β: the angle between the negative z-axis and a straight line connecting the origin 8 to the point 26.

The problem consists of the recording setup optimization so as to provide some domain in the space, where all color images of the diffuser will be overlapped. It is fulfilled in the present invention by means of appropriate selection of the diffuser length and its position in the recording setup.

Now we will derive the relations between the parameters of the recording setup and the image projection system, which have to be satisfied to produce the holographic screen with the specified characteristics.

Using the introduced designations, we can write for the energy distribution in the interference pattern formed on the photoplate surface in course of the recording:

I(x,y)=(Ae^{ikr1}+Be^{ik1r2})(Ae^{-ikr1}+Be^{-ikr2})=A²+B²+ABe^{ik1}(r₁-r₂)+ABe^{1k1}(r₂-r₁) (4)

where A and B are the amplitudes of the electric field in t he reference and object waves, respectively, and k₁ is a wave number of the recording laser light.

In this case, the developed photoplate transmission (i.e., that of the holographic screen) can be presented approximately as follows:

T=T₀−T₁I (x,y)

where T₀ is the transmission of the unexposed photoplate and T₁I(x,y) is the transmission change, caused by the I(x,y). When the holographic screen is illuminated by the projector light (as shown on the FIG. 2) with the wavelength k₂ and wave number k₂, the electric field distribution Eₒᵤₜ of the light transmitted through the holographic screen for arbitrary point x,y on the screen surface can be expressed as follows:

In Equation (6), the first, second and third terms represent a zero order diffracted light, a real image and a virtual image, respectively. If we want to obtain the real image at the point 26 (shown on FIG. 2), spaced apart by the distance R₄ from the screen center, the second term can be approximated as Dexp(-ik₂r₄+φ₀), where φ₀ is the constant phase shift. Therefore, because the constant phase shift is not significant for the wave front focusing, the equation (1) can be met:

k₂r₃+k₁(r₁-r₂)=−k₂r₄+const (1)

Equation (1) will be used now to derive the relationships between R₁, R₂, R₃ and R₄ together with the relations between α and β.

At first, r₁, r₂, r₃ and r₄ can be expressed using the triangular formula as follows:

r₁=\sqrt{R₁²+x²+y²}

Assuming that x and y are much smaller than R₁, R₂, R₃ and R₄. the above equations can be transformed into a Tailor series as follows:

$${r}_{1} ≅ {R}_{1} ( 1 + \frac{{x}^{2} + {y}^{2}}{2 {R}_{1}^{2}} + … ) \\ {r}_{2} ≅ {R}_{2} ( 1 + \frac{{x}^{2} + {y}^{2}}{2 {R}_{2}^{2}} - \frac{{R}_{2} x sin α}{{R}_{2}^{2}} - \frac{{x}^{2} {sin}^{2} α}{2 {R}_{2}^{2}} + … ) \\ {r}_{3} ≅ {R}_{3} ( 1 + \frac{{x}^{2} + {y}^{2}}{2 {R}_{3}^{2}} + … ) \\ {r}_{4} ≅ {R}_{4} ( 1 + \frac{{x}^{2} + {y}^{2}}{2 {R}_{4}^{2}} - \frac{{R}_{4} x sin β}{{R}_{4}^{2}} - \frac{{x}^{2} {sin}^{2} β}{2 {R}_{4}^{2}} + … ) \qquad ( 8 )$$

Substituting the above equations into Equation (1), Equation (1) can be arranged as follows:

$${k}_{2} {R}_{3} + {k}_{1} ( {R}_{1} - {R}_{2} ) + x ( {k}_{1} sin α ) + \frac{{x}^{2} + {y}^{2}}{2} \{ \frac{{k}_{2}}{{R}_{3}} + {k}_{1} ( \frac{1}{{R}_{1}} - \frac{1}{{R}_{2}} ) \} + \frac{{k}_{1} {x}^{2} {sin}^{2} α}{2 {R}_{2}} + … = - {k}_{2} {R}_{4} + const + {k}_{2} x sin β - \frac{{x}^{2} - {y}^{2}}{2} \cdot \frac{{k}_{2}}{{R}_{4}} + \frac{{k}_{2} {x}^{2} {sin}^{2} β}{2 {R}_{4}} \qquad ( 9 )$$

Arranging both sides of Equation (9) with respect to x, y, x² and y^{2,} the following relationships can be established:

k₁sinα=k₂sinβ

$$\frac{{k}_{2}}{{R}_{3}} + \frac{{k}_{1}}{{R}_{1}} + \frac{{k}_{2} {cos}^{2} β}{{R}_{4}} = \frac{{k}_{1} {cos}^{2} α}{{R}_{2}} \\ \frac{{k}_{2}}{{R}_{3}} + {k}_{1} ( \frac{1}{{R}_{1} } - \frac{1}{{R}_{2}} ) = \frac{{k}_{2}}{{R}_{4}} \qquad ( 10 )$$

Solving Equations (10) with respect to α and R₂, the equations (2) and (3) can be obtained.

$$\begin{matrix}α = {sin}^{- 1} ( \frac{{λ}_{1}}{{λ}_{2}} sin β ) & ( 2 ) \\ {R}_{2} = \frac{{R}_{1}}{1 + \frac{2 {λ}_{1}}{{λ}_{2}} \cdot \frac{{R}_{1}}{{R}_{4}}} & ( 3 )\end{matrix}$$

If the coordinates of the point 15 (y=R₂ sin α, z=R₂ cos α) are substituted into equations (2,3) above, then it is seen, that a locus of the point 15 is a hyperbola. Therefore, the diffuser 12 must be curved along the hyperbolic surface. However, if R₁ is increased, the curvature of the diffuser 12 becomes negligible small. Therefore, the long side of the diffuser 12 can be considered as a segment of the straight line. From Equations (2,3), the length and relative position of the diffuser can be found so as to provide a superposition at least at one point of the reconstructed images spatially shifted according to wavelengths difference of the spectral components of the projector light. For illustrative purposes, values of R₂ and a were calculated for several values of λ₂ of the projected wave when the wavelength of the reference wave λ₁ is 0.647 μm (for a krypton laser), R₁=250 cm, R₃=R₄=150 cm and β=15°. The results are shown in Table 1 below.

TABLE 1
Relative Position of a Diffuser for Wavelengths of the
Projected Wave

| λ₂ (μm) | R₂ (cm) | α |
|---|---|---|
| 0.4 | 39.11 | 24.75° |
| 0.5 | 47.05 | 19.57° |
| 0.6 | 54.41 | 16.2° |
| 0.7 | 61.26 | 13.84° |

The length of the diffuser 12 for the values of λ₂ listed in Table 1 was calculated to be 24 cm (it is distance between extreme points of diffuser, corresponding to 0.4 μm and 0.7 μm). From the comparison data from the Table 1 with FIG. 1, it is clear, that the upper end 17 and the lower end 16 of the diffuser 12 are responsible for presence in the viewing zone of red and blue light, respectively.

After exposure the photoplate is developed and bleached. To protect the photoemulsion against possible damage, the emulsion side of the photoplate can be sealed by the photopolymer layer and glass plate.

Referring to the FIG. 2, if the holographic screen 18 has been produced with the diffuser 12 being positioned to satisfy the conditions in Table 1, and R₁, R₂, R₃, R₄, and β are set as defined above, the point 26 becomes a point where the upper point of the reconstructed blue image (having a wavelength of 0.4 μm) and the lower point of the reconstructed red image (having a wavelength of 0.7 μm) are superimposed on each other. As the reconstructed images for all colors are superimposed at point 26, a color image can be seen when the holographic screen is observed through point 26. As the wavelengths of three primary colors required for the reconstruction of real color images occupies more narrow bandwidth, than the range from 0.4 to 0.7 μm, the region where the superposition of images occurs and thus a color image can be seen has some extent of area centered around the point 26.

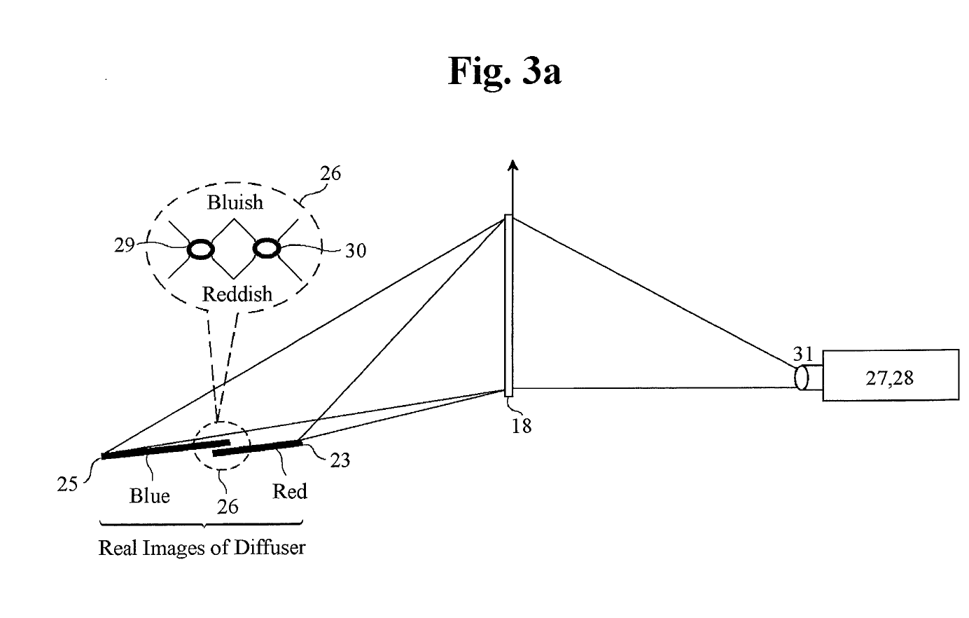

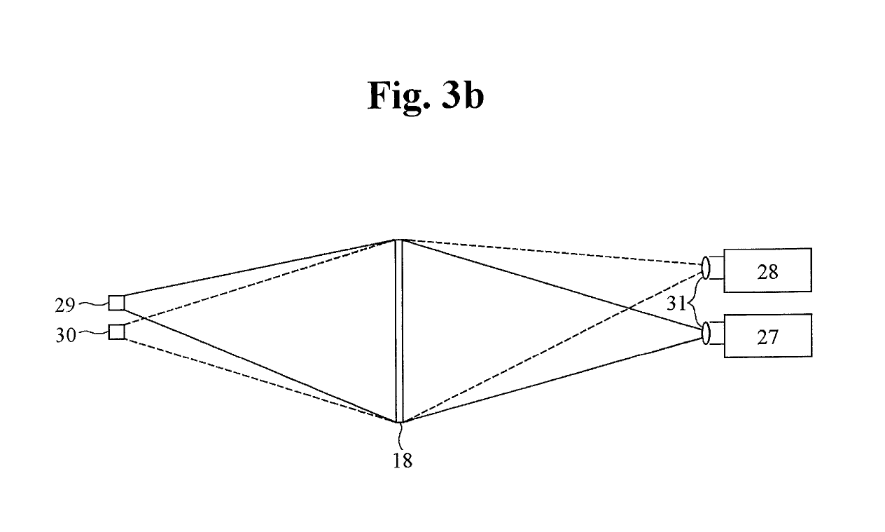

Referring to FIGS. 3a and 3b, an optical arrangement for displaying a stereoscopic image by using a holographic screen produced according to the present invention is shown. The images corresponding to the left and right eyes of a viewer, which is spaced apart by about 1.5 m from the holographic screen 18, are projected to be focused on the holographic screen 18 using two projectors 27, 28 located in symmetry with respect to the x-z plane. The projection lenses of the two projectors 27, 28 are separated by an eye-to-eye distance (6.5 cm). Then, the viewing zones 29, 30 corresponding to the respective projectors are formed opposite to the projectors 27, 28 and on the left side of the holographic screen 18 at the position spaced apart by about 1.5 m from the holographic screen 18. A spacing of about 6.5 cm exists between the viewing zones 29, 30. The width of the viewing zones 29 and 30 amounts approximately to the sum of the width of the aperture of the projection lens 31 and the width of the diffuser. Therefore, when the holographic screen is produced, the width of the diffuser should be small enough to provide that the viewing zones are not overlapping with each other. The viewing zones 29, 30, through which a color image on the screen can be seen, are formed at the center portions of the superposed color images of diffuser 23, 24, 25.

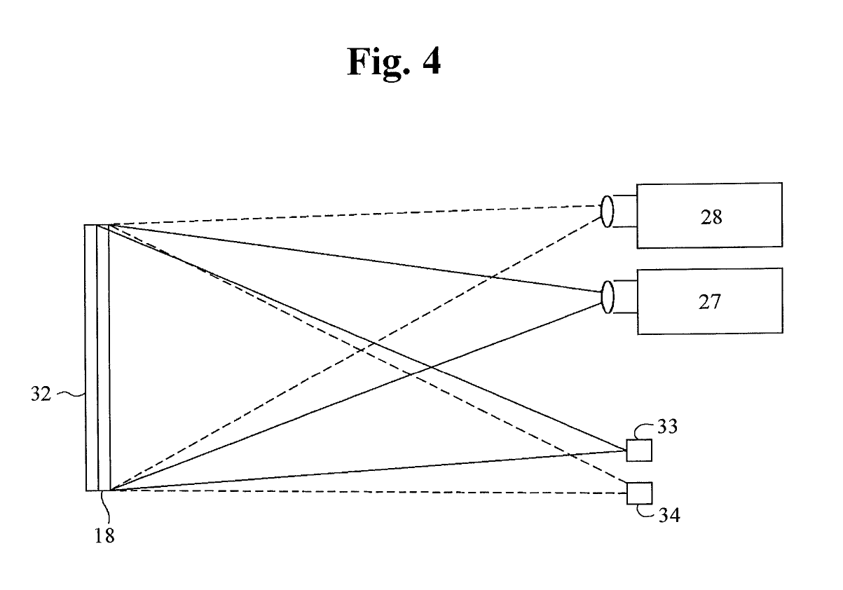

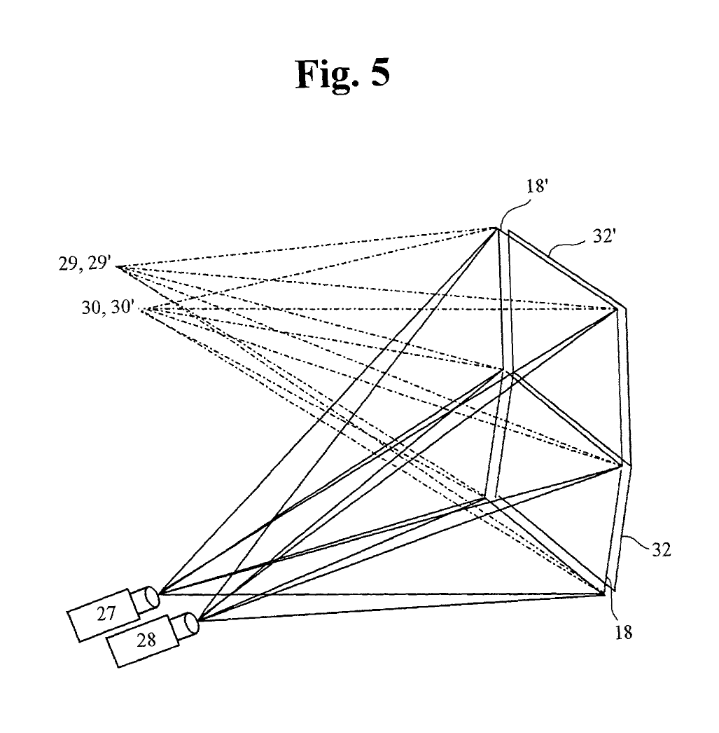

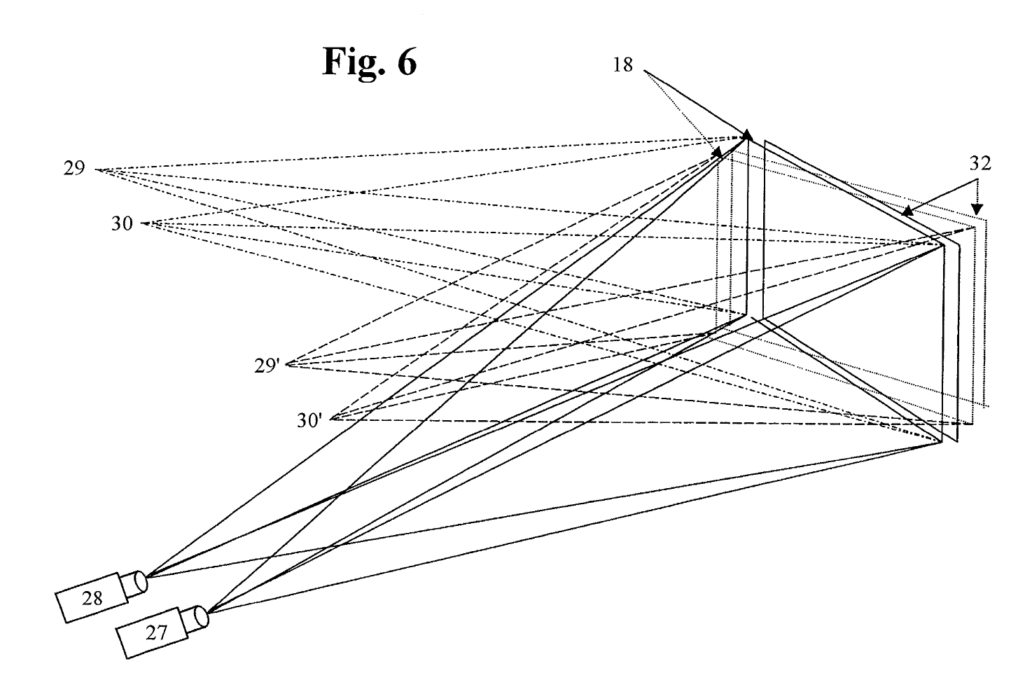

Referring to FIG. 4, an optical arrangement is shown for displaying a three dimensional image by using a holographic screen produced according to the present invention as a reflection type holographic screen. In order to use the holographic screen produced in arrangement of FIG. 1, as a reflection type holographic screen, a reflective mirror 32 may be simply attached to the back side of the holographic screen 18. With this reflection-type holographic screen, the viewing zones 33, 34 are formed on the same side as the projectors 27, 28. In this scheme, the screen photoemulsion is protected by the mirror, sealed to the photoplate of the screen. Small angle rotation of the screen, together with the mirror, produces the shifting of the viewing zones. Possibility of the viewing zones shifting can be used a) to make a big size screen as mosaic of relatively small subscreens which is described more specifically later with reference to FIG. 5 and b) to compensate the viewer's eye movement by the appropriate eye-tracking system which is described more specifically later with reference to FIG. 6.

FIG. 5 is a schematic view of an optical arrangement for producing a big size screen by mosaicking several holographic screens produced according to the present invention in the reflection mode of operation. As shown in FIG. 5, two subscreens 18 and 18′ are combined in the form of mosaic by an adhesive and so forth to provide one big size screen; and mirrors 32 and 32′ are attached to the back sides of the subscreens 18 and 18′, respectively. The subscreens 18 and 18′ are aligned so as to make their respective viewing zones 29 and 29′, and viewing zones 30 and 30′ coincident with each other. Further, it is possible to align three or more subscreens in a mosaic manner, thereby providing a big size screen. It is important to note that all the subscreens used in the mosaic process are identical to each other. Therefore, a viewer can watch images on the big size screen if the viewer's eyes are disposed in a common viewing zone.

FIG. 6 is a schematic view of the optical display system having an eye-tracking capability, wherein the holographic screen produced according to the present invention and operated in the reflection mode can be rotated together with the mirror under a control of the eye-tracking system (not shown). As shown in this figure, a mirror 32 is attached to the back side of a screen 18. The screen 18 together with mirror 32 being illuminated by projectors 27 and 28 produces the viewing zones 29 and 30. The screen 18 can be rotated together with the mirror 32 by a rotating device (not shown), whereby the viewing zones 29 and 30 are shifted to another positions 29′ and 30′, respectively. This rotation of the screen 18 and the mirror 32 may be controlled by the eye-tracking system.

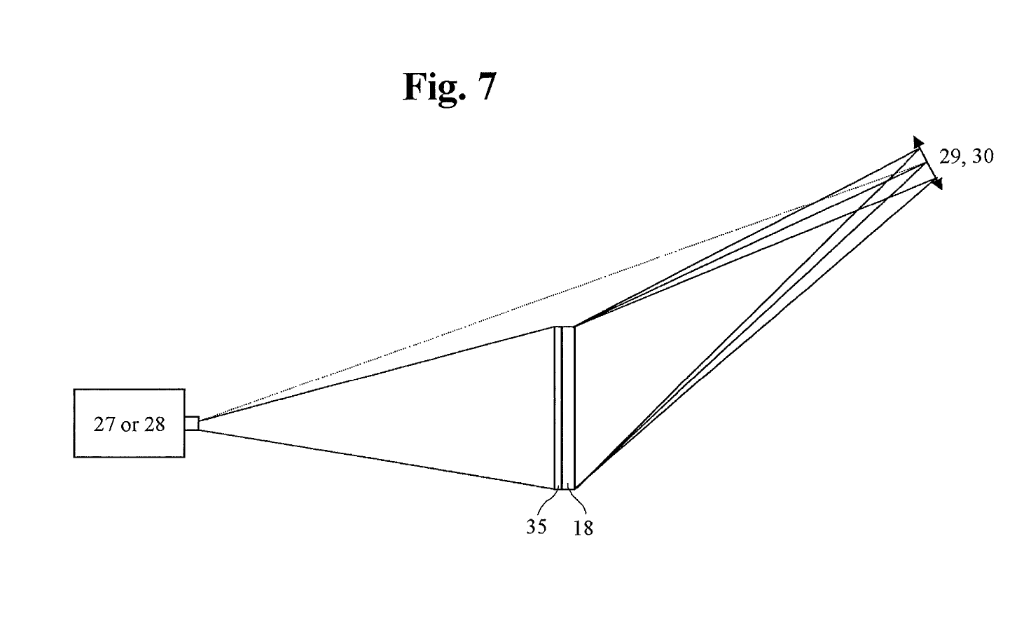

FIG. 7 is a schematic view of the optical display system which is provided with a holographic screen 18 produced according to the present invention, which has an extended vertical size of viewing zone. In FIG. 7, one-dimensional diffuser 35 is attached to the holographic screen 18. Since the diffuser 35 allows lights to be scattered vertically, the vertical size of the viewing zone produced by the holographic screen 18 is increased. Thus, it is not necessary to adjust optical arrangement in the optical display system according to the viewer's height. Such a diffuser can be made as a diffraction grating with vertical dispersion. The diffraction grating has such grating period that neighboring diffraction orders are separated in the viewer position by a distance equal to an viewing zone diameter.

Alternatively, the diffuser can be made as a bleached photograph of a speckle pattern which arises when thin line of laser light is focused on a ground glass. Because the diffuser is disposed in the image plane, image resolution is not worsened by light scattering.

As can be understood from the above, it is possible to mathematically analyze the structure of an apparatus for producing a holographic screen and of an image reproduction apparatus using the holographic screen, to thereby provide an optimized holographic screen for color image display.

The present invention has been described with reference to a particular embodiment in connection with a particular application. Those having ordinary skill in the art and access to the teachings of the present invention will recognize additional modifications and applications within the scope thereof. It is, therefore, intended by the appended claims to cover any and all such applications, modifications, and embodiments within the scope of the present invention.

What is claimed is:

1. An optical display system for displaying stereoscopic or multi-view color images comprising:
a holographic screen; and
two or more image projectors which project the stereoscopic or multi-view color images on said holographic screen, a distance between exit pupils of the two or more image projectors being decided depending on a viewer's inter-eye distance,
wherein said holographic screen is formed by a method including the steps of:
(a) placing a photoplate on an x-y plane of a three dimensional space, wherein the center of the photoplate is disposed in the origin of the three dimensional space;
(b) splitting the laser beam into two beams: reference beam and object beam, both beams being used to illuminate the photoplate surface;
(c) shaping the reference beam as a sperical wave diverging from a point on a z-axis which is located a distance R₁ from the photoplate center;
(d) shaping the object beam so as to illuminate the photoplate through an elongated narrow slit-shaped diffuser inclined to the photoplate surface; and
(e) recording an interference pattern, which is arising as a result of the superposition of the reference wave with an object wave from the diffuser on the photoplate,
whereby the stereoscopic or multiview three dimensional color images is displayed on a recorded screen by the projectors disposed at a distance R₃ from the screen, if a viewer's eyes are placed at viewing zones which are located behind the screen at a distance R₄ the viewing zones being composed of superposed diffuser's real images of the different colors,
wherein the coordinates of the diffuser point, which is responsible for the contribution of a light with a wavelength X₂ in the viewing zone, are calculated from the following equations:
$$\begin{matrix}{k}_{2} {r}_{3} + {k}_{1} ( {r}_{1} - {r}_{2} ) = - {k}_{2} {r}_{4} + const & ( 1 ) \\ α = {sin}^{- 1} [ \frac{{k}_{2}}{{k}_{1}} sin β ] = {sin}^{- 1} [ \frac{{λ}_{1}}{{λ}_{2}} sin β ] & ( 2 ) \\ {R}_{2} = \frac{{R}_{1}}{1 + \frac{2 {λ}_{1} {R}_{1}}{{λ}_{2} {R}_{4}}} & ( 3 )\end{matrix}$$
where r₁ is the distance between an arbitrary point (x,y) on the photoplate and a position of the source of the reference beam; r₂ and R₂ are the distances between a point (x,y) on the photoplate and a point on the diffuser and between the coordinate origin and the same diffuser point; α is the angle between R₂ straight line and the z-axis; r₃ is the distance between a point (x,y) on the photoplate and a point source of the projection beam; r₄ is the distance between a point (x,y) on the photoplate and a viewing zone; R₄ is the distance between an origin and a viewing zone; β is the angle between R₄ straight line and the z-axis; λ₁ and λ₂ represent wavelengths of the recording and projecting waves, respectively; k₁ and k₂ are wave numbers of the recording and projecting waves, respectively,
wherein the diffuser's length and position are calculated using equations (2) and (3) for covering an entire spectral range of a projected image.

2. The optical display system according to claim 1, further comprising a reflecting means attached to the back side of said holographic screen for allowing said holographic screen to operate in a reflection mode.

3. The optical display system according to claim 2, further comprising:
means for rotating said holographic screen; and
an eye-tracking system for tracking a viewer's eye movement to control an operation of said rotating means, whereby said holographic screen is rotated in accordance with the viewer's eye movement.

4. The optical display system according to claim 1, further comprising a vertical diffusing means attached to a surface of said holographic screen,
wherein said vertical diffusing means generates vertical light scattering on the surface of said holographic screen to increase a vertical size of the viewing zone to be formed by said holographic screen.

5. The optical display system according to claim 4, wherein said diffusing means is formed as a bleached photograph of a speckle pattern, said speckle pattern being obtained by scattering a thin line of laser light to a ground glass.

6. The optical display system according to claim 4, wherein said diffusing means is formed as a diffraction grating with vertical direction of dispersion, said diffraction grating having such a grating period that neighboring diffraction orders are separated at the viewer position by a distance equal to an diameter of the viewing zone.

7. An optical display system for displaying a large stereoscopic or multi-view color image comprising:
two or more holographic screens;
means for combining said two or more holographic screens in such a manner that their viewing zones coincide in a viewer's position to form a large holographic screen, to thereby provide the large stereoscopic or multi-view image; and
two or more image projectors which project the large stereoscopic or multi-view color image on said two or more holographic screens, a distance between exit pupils of the two or more image projectors being decided depending on a viewer's inter-eye distance,
wherein each of said two or more holographic screens is formed by a method including the steps of:
(a) placing a photoplate on an x-y plane of a three dimensional space, wherein the center of the photoplate is disposed in the origin of the three dimensional space;
(b) splitting the laser beam into two beams: reference beam and object beam, both beams being used to illuminate the photoplate surface;
(c) shaping the reference beam as a sperical wave diverging from a point on a z-axis which is located a distance R₁ from the photoplate center;
(d) shaping the object beam so as to illuminate the photoplate through an elongated narrow slit-shaped diffuser inclined to the photoplate surface; and
(e) recording an interference pattern, which is arising as a result of the superposition of the reference wave with an object wave from the diffuser on the photoplate,
whereby the large stereoscopic or multiview color image is displayed on a recorded screen by the two or more projectors disposed at a distance R₃ from said two or more holographic screens, if a viewer's eyes are placed at viewing zones which are located behind the screen at a distance R₄, the viewing zones being composed of superposed diffuser's real images of the different colors,
wherein the coordinates of the diffuser point, which is responsible for the contribution of a light with a wavelength λ₂ in the viewing zone, are calculated from the following equations:
$$\begin{matrix}{k}_{2} {r}_{3} + {k}_{1} ( {r}_{1} - {r}_{2} ) = - {k}_{2} {r}_{4} + const & ( 1 ) \\ α = {sin}^{- 1} [ \frac{{k}_{2}}{{k}_{1}} sin β ] = {sin}^{- 1} [ \frac{{λ}_{1}}{{λ}_{2}} sin β ] & ( 2 ) \\ {R}_{2} = \frac{{R}_{1}}{1 + \frac{2 {λ}_{1} {R}_{1}}{{λ}_{2} {R}_{4}}} & ( 3 )\end{matrix}$$
where r₁ is the distance between an arbitrary point (x,y) on the photoplate and a position of the source of the reference beam; r₂ and R₂ are the distances between a point (x,y) on the photoplate and a point on the diffuser and between the coordinate origin and the same diffuser point; α is the angle between R₂ straight line and the z-axis; r₃ is the distance between a point (x,y) on the photoplate and a point source of the projection beam; r₄ is the distance between a point (x,y) on the photoplate and a viewing zone; R₄ is the distance between an origin and a viewing zone; β is the angle between R₄ straight line and the z-axis; λ₁, and λ₂ represent wavelengths of the recording and projecting waves, respectively; k₁ and k₂ are wave numbers of the recording and projecting waves, respectively,
wherein the diffuser's length and position are calculated using equations (2) and (3) for covering an entire spectral range of a projected image.

8. A holographic screen being formed by a method including the steps of:
(a) placing a photoplate on an x-y plane of a three dimensional space, wherein the center of the photoplate is disposed in the origin of the three dimensional space;
(b) splitting the laser beam into two beams: reference beam and object beam, both beams being used to illuminate the photoplate surface;
(c) shaping the reference beam as a sperical wave diverging from a point on a z-axis which is located a distance R₁ from the photoplate center;
(d) shaping the object beam so as to illuminate the photoplate through an elongated narrow slit-shaped diffuser inclined to the photoplate surface; and
(e) recording an interference pattern, which is arising as a result of the superposition of the reference wave with an object wave from the diffuser on the photoplate,
whereby the stereoscopic or multiview three dimensional color images is displayed on a recorded screen by the projectors disposed at a distance R₃ from the screen, if a viewer's eyes are placed at viewing zones which are located behind the screen at a distance R₄, the viewing zones being composed of superposed diffuser's real images of the different colors,
wherein the coordinates of the diffuser point, which is responsible for the contribution of a light with a wavelength λ₂ in the viewing zone, are calculated from the following equations:
$$\begin{matrix}{k}_{2} {r}_{3} + {k}_{1} ( {r}_{1} - {r}_{2} ) = - {k}_{2} {r}_{4} + const & ( 1 ) \\ α = {sin}^{- 1} [ \frac{{k}_{2}}{{k}_{1}} sin β ] = {sin}^{- 1} [ \frac{{λ}_{1}}{{λ}_{2}} sin β ] & ( 2 ) \\ {R}_{2} = \frac{{R}_{1}}{1 + \frac{2 {λ}_{1} {R}_{1}}{{λ}_{2} {R}_{4}}} & ( 3 )\end{matrix}$$
where r₁ is the distance between an arbitrary point (x,y) on the photoplate and a position of the source of the reference beam; r₂ and R₂ are the distances between a point (x,y) on the photoplate and a point on the diffuser and between the coordinate origin and the same diffuser point; α is the angle between R₂ straight line and the z-axis; r₃ is the distance between a point (x,y) on the photoplate and a point source of the projection beam; r₄ is the distance between a point (x,y) on the photoplate and a viewing zone; R₄ is the distance between an origin and a viewing zone; β is the angle between R₄ straight line and the z-axis; λ₁ and λ₂ represent wavelengths of the recording and projecting waves, respectively; k₁ and k₂ are wave numbers of the recording and projecting waves, respectively,
wherein the diffuser's length and position are calculated using equations (2) and (3) for covering an entire spectral range of a projected image.

9. A large holographic screen comprising:
two or more holographic screens; and
means for combining said two or more holographic screens in such a manner that their viewing zones coincide in a viewer's position to form the large holographic screen, to thereby provide a large stereoscopic or multi-view image, wherein each of said two or more holographic screens is formed by a method including the steps of:
(a) placing a photoplate on an x-y plane of a three dimensional space, wherein the center of the photoplate is disposed in the origin of the three dimensional space;
(b) splitting the laser beam into two beams: reference beam and object beam, both beams being used to illuminate the photoplate surface;
(c) shaping the reference beam as a sperical wave diverging from a point on a z-axis which is located a distance R₁ from the photoplate center;
(d) shaping the object beam so as to illuminate the photoplate through an elongated narrow slit-shaped diffuser inclined to the photoplate surface; and
(e) recording an interference pattern, which is arising as a result of the superposition of the reference wave with an object wave from the diffuser on the photoplate,
whereby the stereoscopic or multiview three dimensional color images is displayed on a recorded screen by the projectors disposed at a distance R₃ from the screen, if a viewer's eyes are placed at viewing zones which are located behind the screen at a distance R₄, the viewing zones being composed of superposed diffuser's real images of the different colors,
wherein the coordinates of the diffuser point, which is responsible for the contribution of a light with a wavelength λ₂ in the viewing zone, are calculated from the following equations:
$$\begin{matrix}{k}_{2} {r}_{3} + {k}_{1} ( {r}_{1} - {r}_{2} ) = - {k}_{2} {r}_{4} + const & ( 1 ) \\ α = {sin}^{- 1} [ \frac{{k}_{2}}{{k}_{1}} sin β ] = {sin}^{- 1} [ \frac{{λ}_{1}}{{λ}_{2}} sin β ] & ( 2 ) \\ {R}_{2} = \frac{{R}_{1}}{1 + \frac{2 {λ}_{1} {R}_{1}}{{λ}_{2} {R}_{4}}} & ( 3 )\end{matrix}$$
where r₁ is the distance between an arbitrary point (x,y) on the photoplate and a position of the source of the reference beam; r₂ and R₂ are the distances between a point (x,y) on the photoplate and a point on the diffuser and between the coordinate origin and the same diffuser point; cc is the angle between R₂ straight line and the z-axis; r₃ is the distance between a point (x,y) on the photoplate and a point source of the projection beam; r₄ is the distance between a point (x,y) on the photoplate and a viewing zone; R₄ is the distance between an origin and a viewing zone; β is the angle between R₄ straight line and the z-axis; λ₁ and λ₂ represent wavelengths of the recording and projecting waves, respectively; k₁ and k₂ are wave numbers of the recording and projecting waves, respectively,
wherein the diffuser's length and position are calculated using equations (2) and (3) for covering an entire spectral range of a projected image.
